(19) United States
(12) Patent Application Publication
(10) Pub. No.: US 2017/0160861 A1
(43) Pub. Date: Jun. 8, 2017

(54) METHOD AND APPARATUS FOR OPERATING A SCREEN OF A TOUCH SCREEN DEVICE

(71) Applicant: Alcatel Lucent, Boulogne Billancourt (FR)

(72) Inventors: Futang Wang, Shanghai (CN); Jiongxuan Chen, Shanghai (CN); Hongbo Zhang, Shanghai (CN); Yunbo Pei, Shanghai (CN); Na Ni, Shanghai (CN); Leitao Zhi, Shanghai (CN)

(73) Assignee: Alcatel Lucent, Boulogne Billancourt (FR)

(21) Appl. No.: 15/322,564

(22) PCT Filed: Jun. 25, 2015
(86) PCT No.: PCT/IB2015/001252

§ 371 Date: Dec. 28, 2016

(30) Foreign Application Priority Data
Jun. 30, 2014 (CN) 201410306788.9

(51) Int. Cl. G06F 3/041; G06F 3/0488

(52) U.S. Cl. CPC G06F 3/0416; G06F 3/04886

(57) ABSTRACT

An objective of the present invention is to provide a method and apparatus for operating a screen of a touch screen device. If a first input operation information of a user matches the input operation information preset for launching a single-handed mode, divide the screen into N (N>1) main zones according to preset configuration information, wherein one main zone is an operating zone, the operating zone being divided into N sub-zones, and the N main zones having a one-to-one correspondence to the N sub-zones; obtain a second input operation information of a user with respect to the operating zone, the second input operation information being for operating a sub-zone therein; determine a main zone corresponding to the sub-zone; and exchange positions of the determined main zone and the operating zone. By using the present invention, the user may perform single-handed operations of all contents within the touch screen, and meanwhile various advantages of a large touch screen are maintained.

### FIELD OF THE INVENTION

The present invention relates to the field of communication technologies, and more specifically to a technology of operating a touch screen device.

### BACKGROUND OF THE INVENTION

A touch screen device has been widely applied in people's daily life, e.g., a smart phone, a tablet computer, etc. In order to satisfy users' increasing demand on comfort reading, screens of current touch screen devices have become bigger and bigger. It is true that a large touch screen will bring many conveniences for use, for example, more contents may be displayed in one screen; the size of display content (e.g., font size, icon size, etc.) can be bigger so as to facilitate reading; and compared with a small touch screen, users can view more information with fewer operations of scrolling the screen and switching pages.

However, a large touch screen device also brings new issues to users, especially for a smart phone with a large screen. Because the screen becomes larger, a user has to operate with both hands at many times, with one hand holding the touch screen device and the other hand operating the screen. The larger the touch screen is, the lower the possibility of single-hand operation is, because in the case of a single-hand operation, the user usually has to grab the device first, then there would be only a thumb left movable, while the moving area of the thumb is very limited under the precondition of keeping hold of the device. The larger the screen is, the smaller the active region of the thumb relative to the screen is, and for a region inaccessible for thumb activities, the user cannot perform operations. Therefore, it would be impossible to perform a single-handed operation on the whole region of the screen, which undoubtedly dampens user experience.

Therefore, for a large touch screen device, it is a problem that needs solving regarding how to perform a single-handed operation on all contents in the screen. The single-handed screen operation herein refers to operation of all contents within the screen only by one hand.

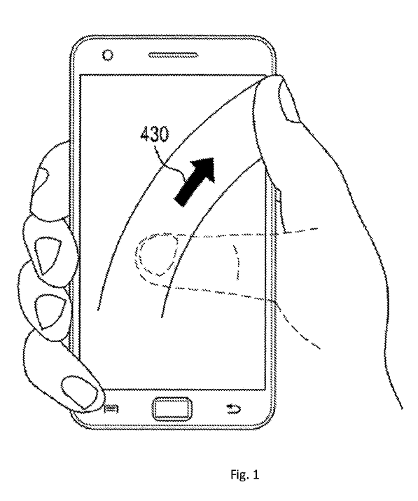

In patent application WO2013176472 A1 filed by Samsung Corporation, there discloses a method for single-handed operation of a user interface of a touch screen. As shown in FIG. 1, that method defines a “comfort zone”, e.g., zone 430 as shown in FIG. 1. That comfort zone is a sector area or a part of the sector area on the screen which is accessible by a thumb of a user performing a single-handed operation. The user may set the shape and size of the comfort zone. Then, all contents on the touch screen are mapped within the comfort zone. These contents include various icons (e.g., icons in the initial interface), an application control interface (e.g., play, pause, stop, etc. in video play), web page browsing (e.g., previous page and next page in a web page or an e-book) and list browsing, etc. In other words, all contents on the touch screen will be arranged in the comfort zone. Because the user interface of the touch screen is completely included within the comfort zone, the user may conveniently operate it with a thumb, while the other four fingers are for holding the touch screen device, thereby single-handed operation is achieved.

Although that method may perform single-handed operation on a touch screen, it sacrifices many advantages of a large touch screen. Because the contents on the original large screen should be completely arranged in a much smaller comfort zone, what can be done is only down-sizing such contents (e.g., down-sizing the icons, down-sizing the buttons, etc.), or narrowing down the gaps between respective contents, or reducing the amount of contents displayed on one page and placing the content that cannot be displayed on the page to the next page. However, such advantages are usually the reason why the user selects a large touch screen device.

Moreover, in order to implement that method, software and hardware of the touch screen device needs to be changed considerably. First, the mapping algorithm for mapping contents on the original large screen to a comfort zone is relatively complex. Second, in order to adapt to the comfort zone, user interfaces of all applications need to be re-designed.

It is seen that the method proposed by Samsung Corporation still has a lot of issues, which also dampens user experience. Therefore, it is desirable to provide a method that facilitates single-handed operation on a screen of a touch screen device.

### SUMMARY OF THE INVENTION

An objective of the present invention is to provide a method and apparatus for operating a screen of a touch screen device.

According to a first aspect of the present invention, there is provided a method for operating a screen in a touch screen device, the method comprising steps of: responding to a first input operation information of a user, determining whether the first input operation information matches input operation information preset for launching a single-handed mode; if the first input operation information matches the input operation information preset for launching a single-handed mode, dividing the screen into N (N>1) main zones based on preset configuration information, wherein one main zone is an operating zone, the operating zone being divided into N sub-zones, and the N main zones having a one-to-one correspondence to the N sub-zones;

obtaining a second input operation information of a user with respect to the operating zone, the second input operation information being for operating a sub-zone therein; determining a main zone corresponding to the sub-zone; and exchanging the positions of the determined main zone and the operating zone.

Preferably, the method further comprises: receiving a third input operation information of a user, the third input operation information including at least one of the following: the amount N of the main zones, which of the N main zones is taken as the operating zone, and a corresponding relationship between the N main zones and the N sub-zones; and updating the configuration information according to the third input information.

Preferably, the method further comprises: responding to a fourth input operation information of a user, determining whether the fourth input operation information matches input operation information preset for position restoration; if the fourth input operation information matches the input operation information preset for position restoration, re-exchanging the positions of the main zone and the operation zone whose positions have been exchanged.

Preferably, the method further comprises: responding to a fifth input operation information of a user, determining whether the fifth input operation information matches input operation information preset for cancelling a single-handed mode; if the fifth input operation information matches the input operation information preset for cancelling a single-handed mode, restoring the screen to be a normal display pattern.

Preferably, the method further comprises: updating the input operation information for launching a single-handed mode according to the input of a user.

Preferably, the method further comprises: updating the input operation information for position restoration according to the input of a user.

Preferably, the method further comprises: updating the input operation information for canceling a single-handed mode according to the input of a user.

Preferably, the method further comprises: the display effect of the operating zone being different from the display effect of other N−1 main zones.

According to a second aspect of the present invention, there is provided an apparatus for operating a screen in a touch screen device, the apparatus comprising: a first determining module configured to, responding to a first input operation information of a user, determine whether the first input operation information matches input operation information preset for launching a single-handed mode; a dividing module configured to, when the first input operation information matches the input operation information preset for launching a single-handed mode, divide the screen into N (N>1) main zones based on preset configuration information, wherein one main zone is an operating zone, the operating zone being divided into N sub-zones, and the N main zones having a one-to-one correspondence to the N sub-zones; an obtaining module configured to obtain a second input operation information of a user with respect to the operating zone, the second input operation information being for operating a sub-zone therein; and a position exchanging module configured to exchange the positions of the determined main zone and the operating zone.

Preferably, the apparatus further comprises: a receiving module configured to receive a third input operation information of a user, the third input operation information including at least one of the following: the amount N of the main zones, which of the N main zones is taken as the operating zone, and a corresponding relationship between the N main zones and the N sub-zones; and a first updating module configured to update the configuration information according to the third input information.

Preferably, the apparatus further comprises: a third determining module configured to, responding to a fourth input operation information of a user, determine whether the fourth input operation information matches input operation information preset for position restoration; the position exchanging module is further configured to, when the fourth input operation information matches the input operation information preset for position restoration, re-exchange the positions of the main zone and the operation zone whose positions have been exchanged.

Preferably, the apparatus further comprises: a fourth determining module configured to, responding to a fifth input operation information of a user, determine whether the fifth input operation information matches input operation information preset for cancelling a single-handed mode; the dividing module is further configured to, when the fifth input operation information matches the input operation information preset for cancelling a single-handed mode, restore the screen to be a normal display pattern.

Preferably, the apparatus further comprises: a second updating module configured to update the input operation information for launching a single-handed mode according to user input.

Preferably, the apparatus further comprises: a third updating module configured to update the input operation information for position restoration according to user input.

Preferably, the apparatus further comprises: a fourth updating module configured to update the input operation information for canceling a single-handed mode according to user input.

Preferably, the display effect of the operating zone is different from the display effect of other N−1 main zones.

The method of the present invention may implement single-handed operation on all contents within the touch screen. Compared with the existing method of single-handed operation of a touch screen, the method of the present invention has the following advantages: 1) compatible with the existing applications, such that various applications (including a user interface, etc.) do not need change. 2) simple to implement, which needn't a complex conversion algorithm, but just needs to exchange the positions of two zones. 3) not required to narrow down the size and spacing between contents within the screen, which guarantees the user's reading comfort and operation comfort. 4) the contents on the original screen are not reduced, thereby ensuring the large-capacity advantage of the large touch-screen. 5) satisfying a variety of needs of various users, flexible in setting, and simple for operation.

BRIEF DESCRIPTION OF THE ACCOMPANYING DRAWINGS

Through reading detailed description of the non-limiting embodiments with reference to the following accompanying drawings, other features, objectives, and advantages of the present invention will become more apparent:

FIG. 1 shows a schematic diagram of a method for single-handed operation on a touch screen applying the prior art;

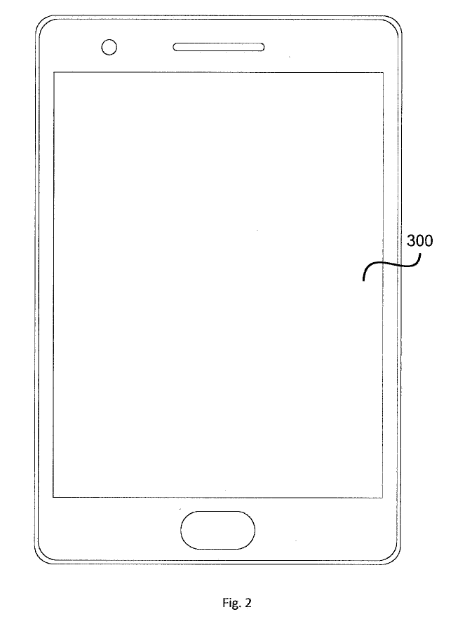

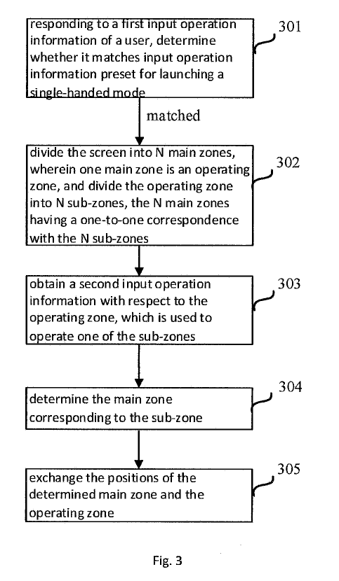

FIG. 2 shows a schematic diagram of a touch screen device according to one embodiment of the present invention;

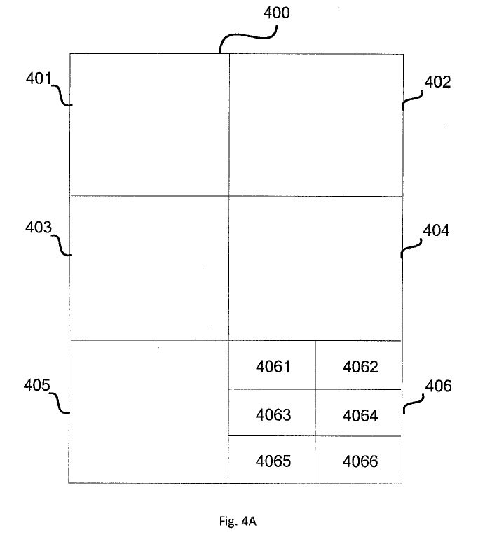

FIG. 3 shows a flow diagram of a method for operating a screen in a touch screen device according to one embodiment of the present invention;

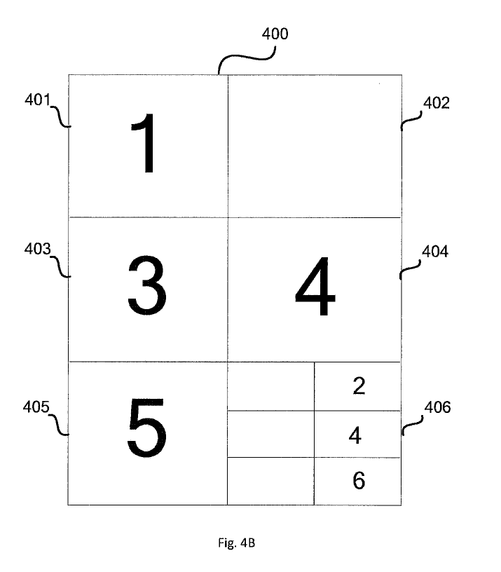

FIG. 4A shows a schematic diagram of a screen for a touch screen device according to one embodiment of the present invention;

FIG. 4B shows a schematic diagram of a screen for a touch screen device according to one embodiment of the present invention;

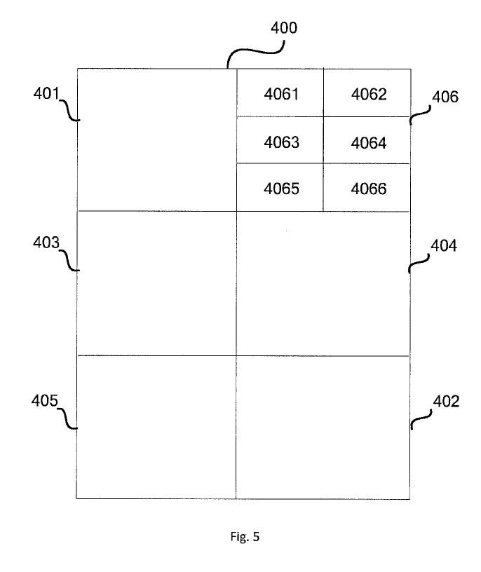

FIG. 5 shows a schematic diagram of a screen for a touch screen device according to one embodiment of the present invention;

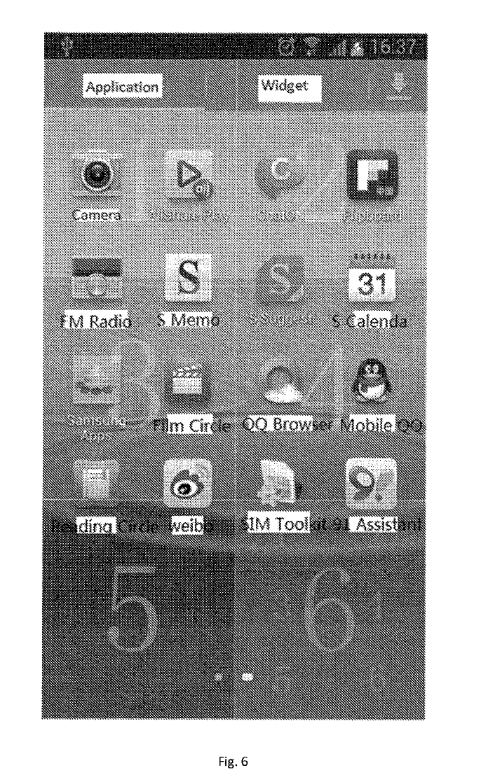

FIG. 6 shows a schematic diagram of a screen for a touch screen device according to one embodiment of the present invention;

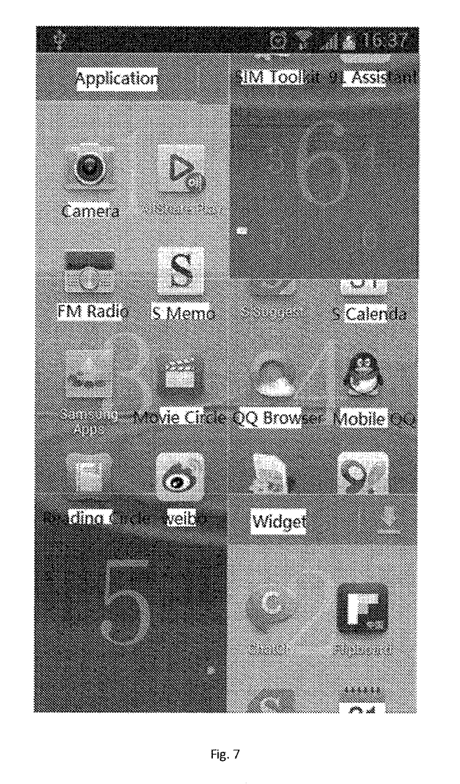

FIG. 7 shows a schematic diagram of a screen for a touch screen device according to one embodiment of the present invention;

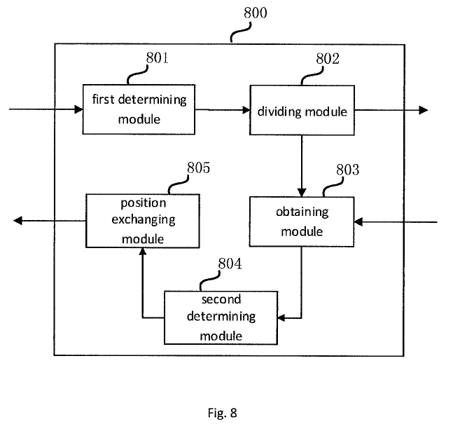

FIG. 8 shows a schematic diagram of an apparatus for operating a screen in a touch screen device according to one embodiment of the present invention.

In the accompanying drawings, same or like reference numerals represent same or similar components.

### DETAILED DESCRIPTION

Hereinafter, the present invention will be described in further detail with reference to the accompanying drawings.

FIG. 2 shows a schematic diagram of a touch screen device according to one embodiment of the present invention. Here, the touch screen device includes, but not limited to, for example, a smart phone having a touch screen, a PDA having a touch screen, or other device having a touch screen, etc. The device comprises a touch screen 400. Because the touch screen 400 is relatively large, when the user operates the screen only with a single hand, the thumb can only reach a portion of the screen, and therefore, it cannot operate on all contents within the screen.

The present invention introduces a new mode, i.e., a single-handed mode, for a touch screen device. The system may preset input operation information that launches the single-handed mode. The input operation information as described here refers to various input information that may be captured by the touch screen device, including, but not limited to, physical actions on the screen of the touch screen device, physical actions on physical buttons (e.g., home key, power key, other physical control key, etc.) or physical actions on the touch screen device per se, e.g., clicking the screen, sliding on the screen, drawing a particular pattern on the screen, inputting text information, pressing a physical key for M (M≧1) times, or shaking the touch screen device in a certain manner, etc.

Hereinafter, it would be mentioned that in a single-handed mode, the display manner of the screen of the touch screen device may be varied somewhat. We refer to the display before the present invention introduced as normal display to differentiate.

FIG. 3 shows a flow diagram of a method for operating a screen in a touch screen device according to one embodiment of the present invention. Hereinafter, the method will be described in detail with reference to FIGS. 4 and 5.

The method starts from step S301.

In step S301, responding to a first input operation information of a user, it is determined whether the first input operation information matches input operation information preset for launching a single-handed mode. The meaning of the input operation information here is identical to what is mentioned above. The touch screen device obtains the first input operation information by interacting with the user, and then judges whether the first input operation information matches the input operation information preset by the system for launching a single-handed mode. For example, the input operation information present for launching the single-handed mode is up-down shaking the touch screen device, then when the first input operation information captured by the touch screen device is up-down shaking, it will be determined that the first input operation information matches the input operation information preset for launching a single-handed mode, while when the first input operation information captured by the touch screen device is other operations, a corresponding action will be taken according to an existing processing procedure.

Preferably, the touch screen device may update the input operation information preset for launching a single-handed mode based on a user's input information. A user may define new input operation information for launching a single-handed mode based on own preferences and use habits.

In step S302, if the first input operation information matches the preset input operation information for launching a single-handed mode, then the single-handed mode is launched. Specifically, based on the preset configuration information, the screen of the touch screen device is divided into N (N>1) main zones, wherein one main zone is an operating zone, the operating zone being divided into N sub-zones, the N main zones having a one-to-one correspondence with the N sub-zones. These N main zones do not overlap with each other; moreover, the N main zones completely cover the screen of the touch screen device. The N sub-zones do not overlap with each other; moreover, the N sub-zones completely cover the operating zone. The operating zone may be a zone accessible to the thumb or a zone easily operated when the user performs a single-handed operation. While the remaining N−1 main zones are zones inaccessible to the thumb or zones not easy operated when the user performs a single-handed operation.

The configuration information herein includes:
The amount N of the main zones,
Which of the N main zones is taken as an operating zone,
The correspondence relationship between the N main zones and the N sub-zones.

Preferably, the touch-screen device may provide a menu in the system setting menu for a user to modify the above configuration information. The touch screen device receives a third input operation information of a user, the third input operation information including at least one of the following information:
The amount N of the main zone,
Which of the N main zones is taken as an operating zone,
The correspondence relationship between the N main zones and the N sub-zones;

Then, the above configuration information is updated based on the third input information. The user may set these configuration information based on the size of the touch screen device and his/her own operation habits. For example, if the screen is large, more main zones may be divided, while if the screen is not very large, less main zones may be divided. If the user is accustomed to right-handed operation, the main zone at the lower right corner of the screen may be set as the operating zone, while if the user is accustomed to left-handed operation, then the main zone at the lower left corner of the screen may be set as the operating zone. Further, if some users are accustomed to grasp the middle portion of the touch screen device, even the main zone in the middle portion of the screen may be set as the operating zone. By modifying the configuration information preset by the system, flexible management may be achieved to satisfy various needs of different users.

It should be understood that the main zones and sub-zones as described herein are not only physical positions of respective zones on the screen when dividing the screen, but also include all contents displayed on the screen within respective zones when dividing the screen. These contents include, but not limited to, various icons (e.g., icons in the initial interface), an application control interface (e.g., play, pause, stop in video playing), webpage browsing (e.g., a previous page and a next page in a webpage or an e-book), and list browsing, etc. We may regard the screen as a jigsaw, while these main zones and sub-zones are respective fragments constituting this jigsaw.

FIG. 4A shows a schematic diagram of a screen of a touch screen device after performing step S302 according to one embodiment of the present invention. In this embodiment, the screen 400 before the touch screen device launches the single-handed mode is shown in FIG. 2. After the single-handed mode is launched, i.e., step S302 is performed, the screen 400 is divided into 6 main zones, which are main zone 401, main zone 402, main zone 403, main zone 404, main zone 405, and main zone 406, respectively. All of the main zones here are rectangular. Wherein, the main zone 406 at the lower right corner is determined as the operating zone. The operating zone 406 is further divided into 6 sub-zones, which are sub-zone 4061, sub-zone 4062, sub-zone 4063, sub-zone 4064, sub-zone 4065, and sub-zone 4066, respectively. All of the sub-zones here are rectangular. Wherein, the main zone 401 corresponds to the sub-zone 4061, the main zone 402 corresponds to the sub-zone 4062, the main zone 403 corresponds to the sub-zone 4063, the main zone 404 corresponds to the sub-zone 4064, the main zone 405 corresponds to the sub-zone 4065, and the main zone 406 corresponds to the sub-zone 4066.

FIG. 4B shows a schematic diagram of a screen of the touch screen device after step S302 is performed according to a further embodiment of the present invention. In this embodiment, the screen 400 of the touch screen device before launching the single-handed mode is shown in FIG. 2. After launching the single-handed mode, i.e., after performing S302, the division of the screen 400 is identical to FIG. 4A, except that in FIG. 4B, the 6 main zones of the screen 400 are marked with semi-transparent numbers so as to facilitate the user to use: the screen of the main zone 401 is labeled with a semi-transparent number 1; the screen of the main zone 402 is labeled with a semi-transparent number 2; the screen of the main zone 403 is labeled with a semi-transparent number 3; the screen of the main zone 404 is labeled with a semi-transparent number 4; the screen of the main zone 405 is labeled with a semi-transparent number 5; while the screen of the main zone 406 is labeled with a semi-transparent number 6.

Likewise, the 6 sub-zones are labels with semi-transparent numbers as well: the screen of the sub-zone 4061 is labeled with a semi-transparent number 1; the screen of the sub-zone 4042 is labeled with a semi-transparent number 2; the screen of the sub-zone 4063 is labeled with a semi-transparent number 3; the screen of the sub-zone 4064 is labeled with a semi-transparent number 4; the screen of the sub-zone 4065 is labeled with a semi-transparent number 5; while the screen of the sub-zone 4066 is labeled with a semi-transparent number 6. With such identifications, the user may clearly know the main zone corresponding to each sub-zone, so as to facilitate operation.

In a further embodiment, the display effect of the operating zone 406 may also be set with a display effect different from other main zones. For example, the display effect of the main zones 401-405 is normal, while the display effect of the operating zone 406 is semi-transparent, so as to facilitate the user to clearly know which main zone is set as the operating zone.

In step S303, the touch screen device obtains a user's second input operation information with respect to the operating zone, the second input operating information being for operating a sub-zone therein. In the embodiment as shown in FIG. 4A, the touch screen device captures the user's input operation information with respect to the operating zone 406, e.g., the user clicks the sub-zone 4062 in the operating zone 406.

Then, in step S304, a main zone corresponding to said sub-zone is determined. For example, in the embodiment as shown in FIG. 4A, when the user clicks the sub-zone 4062 in the operating zone 406, the touch screen device will determine the main zone corresponding to the sub-zone 4062 is 402.

Next, in step S305, exchange the positions of the determined main zone and the operating zone. It should be noted that exchanging the positions of the first zone and the second zone here means all contents in the first zone are completely exchanged to the initial position of the second zone, while all contents of the second zone are completely exchanged to the initial position of the first zone. For example, in the embodiment as shown in FIG. 4A, when the user clicks the sub-zone 4062 in the operating zone 406, the touch screen device will determine a main zone corresponding to the sub-zone 4062 is 402; then, the positions of the main zone 402 and the operating zone 406 are exchanged. At this time, the display effect of the screen 400 is shown in FIG. 5. Because the operating zone 406 as shown in FIG. 4A is a zone that is easily operated by a thumb when single-handed operating, when the main zone 402 in FIG. 4A is exchanged to the position of the operating zone 406 in FIG. 4A, as shown in FIG. 5, the main zone 402 will become the zone that is easily operated when single-handed operating, while the main zone 402 as shown in FIG. 4A is the zone that is not easily operated by a thumb when single-handed operating. In this way, in the screen as shown in FIG. 5, the user can single-handed operate the contents in the main zone 402 very conveniently.

In a further embodiment, the method of the present invention further comprises a step S306 (not shown in the figures) and a step S307 (not shown in the figures).

In step S306, responding to a fourth input operation information of a user, the touch screen device determines whether the fourth input operation information matches the preset input operation information for position restoration. For example, when the input operation information preset by the system for position restoration is clicking the screen beyond the operating zone thrice, then when the fourth input operation information captured by the touch screen device is clicking the screen beyond the operating zone thrice, it will be determined that the fourth input operation information matches the preset input operation information for position restoration.

Preferably, the touch screen device may update the input operation information preset for position restoration based on a user's input information. A user may define new input operation information for position restoration based on his/her own preferences and use habits.

In step S307, if the fourth input operation information matches the input operation information preset for position restoration, re-exchange the positions of the main zone and the operating zone whose positions have been exchanged. For example, in the above embodiment, the screen after the positions of the main zone 402 and the operating zone 406 have been exchanged is shown in FIG. 5. Then, when the user's input operation information matches the input operation information preset for position restoration, the positions of the main zone 402 and the operating zone 406 (as shown in FIG. 5) that have exchanged their positions will be re-exchanged again. The screen after the re-exchange is shown in FIG. 4A.

With the method of the present invention, the user may perform single-handed operation of all contents in the screen. After the single-handed mode is launched, if the user intends to operate contents within a certain main zone, it is only needed to operate the sub-zone corresponding to the main zone within the operating zone; then, the position of the main zone will be exchanged with the position of the operating zone, such that the zone will be within a scope that is easily operated when single-handed operating, and the user would easily single-handed operate all contents within the zone.

In a further embodiment, the method of the present invention further includes step S308 (not shown in the figures) and step S309 (not shown in the figures).

In step S308, responding to a fifth input operation information of a user, determine whether the fifth input operation information matches preset input operation information for cancelling the single-handed mode. For example, if the input operation information preset by the system for cancelling the single-handed mode is up-down shaking the touch screen device, then when the fifth input operation information captured by the touch screen device is up-down shaking, it will be determined that the fifth input operation information matches the input operation information preset for cancelling the single-handed mode.

Preferably, the touch screen device may update the input operation information preset for canceling the single-handed mode based on a user's input information. A user may define new input operation information for cancelling the single-handed mode based on his/her own preferences and use habits.

In step S309, if the fifth input operation information matches input operation information preset for cancelling the single-handed mode, restore the screen to a normal display pattern. For example, when the screen 400 is as shown in FIG. 4A or FIG. 4B or FIG. 5, if the user's input operation information matches the input operation information preset for canceling the single-handed mode, then the screen 400 will be restored to the pattern of the screen before launching the single-handed mode, the pattern shown in FIG. 2.

FIG. 6 shows a schematic diagram of a screen of a touch screen device according to one embodiment of the present invention. In this embodiment, the user launches a single-handed mode of the touch screen device. The screen is divided into 6 main zones, each main zone being marked with a semi-transparent number identification, wherein the main zone 6 at the lower right corner is taken as the operating zone, while the operating zone is further divided into 6 sub-zones, each sub-zone being flagged with a semi-transparent number identification respectively. Wherein, the main zone 1 corresponds to the sub-zone 1; the main zone 2 corresponds to the sub-zone 2; the main zone 3 corresponds to the sub-zone 3; the main zone 4 corresponds to the sub-zone 4; the main zone 5 corresponds to the sub-zone 5; the main zone 6 corresponds to the sub-zone 6. Because the screen of the touch screen device is relatively large, when the user holds the touch screen device with one hand, the thumb cannot reach the ChatOn application in the main zone 2. Then the user clicks the sub-zone 2 located in the operating zone 6, the positions of the operating zone 6 and the main zone 2 are exchanged and the screen after the positions exchange is shown in FIG. 7. It may be seen that in FIG. 7, the main zone 2 is moved to the original position of the operating zone 6, while this position is within a zone accessible to the thumb when the user performs single-handed operations. Now, the user can easily operate all contents within the main zone 2, and use the application by clicking the ChatOn icon therein.

FIG. 8 shows a schematic diagram of an apparatus for operating a screen in a touch screen device according to one embodiment of the present invention. The apparatus 800 comprises: a first determining module 801, a dividing module 802, an obtaining module 803, a second determining module 804, and a position exchanging module 805.

Hereinafter, the working process of the apparatus 800 will be described in detail with reference to FIGS. 2, 4A, 4B, and 5.

First, the first determining module 801, responding to a first input operation information of a user, determines whether the first input operation information matches input operation information preset for launching the single-handed mode. The meaning of the input operation information here is identical as above. The touch screen device obtains the first input operation information by interacting with the user, and then judges whether the first input operation information matches the input operation information preset by the system for launching the single-handed mode. For example, the input operation information preset for launching the single-handed mode is up-down shaking the touch screen device, then when the first input operation information captured by the touch screen device is up-down shaking, the first determining module 801 will determine that the first input operation information matches the input operation information preset for launching a single-handed mode, while when the first input operation information captured by the touch screen device is other operations, a corresponding action will be taken according to an existing processing procedure.

Preferably, the apparatus 800 further comprises a second updating module (not shown in the figures). The second updating module may update the input operation information preset for launching a single-handed mode based on a user's input information. A user may define new input operation information for launching the single-handed mode based on own preferences and use habits.

If the first input operation information matches the preset input operation information for launching the single-handed mode, then the single-handed mode is launched. Specifically, based on the preset configuration information, the screen of the touch screen device is divided into N (N>1) main zones by the dividing module 802, wherein one main zone is the operating zone, the operating zone being divided into N sub-zones, and the N main zones having a one-to-one correspondence with the N sub-zones. These N main zones do not overlap with each other; moreover, the N main zones completely cover the screen of the touch screen device. The N sub-zones do not overlap with each other; moreover, the N sub-zones completely cover the operating zone. The operating zone may be a zone accessible to the thumb or a zone easily operated when the user performs single-handed operations, while the other N−1 main zones are zones inaccessible to the thumb or zones not easy for being operated when the user performs single-handed operations compared to the operating zone.

The configuration information here includes:
The amount N of the main zones,
Which of the N main zones is taken as the operating zone,
The correspondence relationship between the N main zones and the N sub-zones.

Preferably, the touch-screen device further comprises a receiving module (not shown in the figures) and a first updating module (not shown in the figures). The touch screen device may provide a menu in the system setting menu for a user to modify the above configuration information. The receiving module receives a third input operation information of a user, the third input operation information including at least one of the following information:
The amount N of the main zone,
Which of the N main zones is used as the operating zone,
The correspondence relationship between the N main zones and the N sub-zones;

Then, the first updating module updates the above configuration information based on the third input information. A user may set these configuration information based on the size of the touch screen device and his/her own operation habits. For example, if the screen is very large, more main zones may be divided, while if the screen is not very large, less main zones may be divided. If the user is accustomed to right-handed operation, the lower right corner of the screen may be set as the operating zone, while if the user is accustomed to left-handed operation, then the main zone at the lower left corner of the screen may be set as the operating zone. Further, if some users are accustomed to grasp the middle portion of the touch screen device, even the main zone in the middle portion of the screen may be set as the operating zone. By modifying the configuration information preset by the system, flexible management may be achieved to satisfy various needs of different users.

It should be understood that the main zones and sub-zones as described herein are not only physical positions of respective zones on the screen when dividing the screen, but also include all contents displayed on the screen within respective zones when dividing the screen. These contents include, but not limited to, various icons (e.g., icons in the initial interface), an application control interface (e.g., play, pause, stop in video playing), webpage browsing (e.g., a previous page and a next page in a webpage or an e-book), and list browsing, etc. We may regard the screen as a jigsaw, while these main zones and sub-zones are respective fragments constituting this jigsaw.

FIG. 4A shows a schematic diagram of a screen of a touch screen device after performing step S302 according to one embodiment of the present invention. In this embodiment, the screen 400 before the touch screen device launches the single-handed mode is shown in FIG. 2. After the single-handed mode is launched, the screen 400 is divided into 6 main zones by the dividing module 802, i.e., main zone 401, main zone 402, main zone 403, main zone 404, main zone 405, and main zone 406, respectively. All of the main zones here are rectangular. Wherein, the main zone 406 at the lower right corner is determined as the operating zone. The operating zone 406 is further divided into 6 sub-zones, which are sub-zone 4061, sub-zone 4062, sub-zone 4063, sub-zone 4064, sub-zone 4065, and sub-zone 4066, respectively. All of the sub-zones here are rectangular. Wherein, the main zone 401 corresponds to the sub-zone 4061, the main zone 402 corresponds to the sub-zone 4062, the main zone 403 corresponds to the sub-zone 4063, the main zone 404 corresponds to the sub-zone 4064, the main zone 405 corresponds to the sub-zone 4065, and the main zone 406 corresponds to the sub-zone 4066.

FIG. 4B shows a schematic diagram of a screen of the touch screen device after launching the single-handed mode according to a further embodiment of the present invention. In this embodiment, the screen 400 of the touch screen device before launching the single-handed mode is shown in FIG. 2. As shown in FIG. 2, after launching the single-handed mode, the division of the screen 400 is identical to FIG. 4A, except that in FIG. 4B, the 6 main zones of the screen 400 are marked with semi-transparent numbers so as to facilitate the user to use: the screen of the main zone 401 is labeled with a semi-transparent number 1; the screen of the main zone 402 is labeled with a semi-transparent number 2; the screen of the main zone 403 is labeled with a semi-transparent number 3; the screen of the main zone 404 is labeled with a semi-transparent number 4; the screen of the main zone 405 is labeled with a semi-transparent number 5; while the screen of the main zone 406 is labeled with a semi-transparent number 6. Likewise, the 6 sub-zones are labels with semi-transparent numbers as well: the screen of the sub-zone 4061 is labeled with a semi-transparent number 1; the screen of the sub-zone 4042 is labeled with a semi-transparent number 2; the screen of the sub-zone 4063 is labeled with a semi-transparent number 3; the screen of the sub-zone 4064 is labeled with a semi-transparent number 4; the screen of the sub-zone 4065 is labeled with a semi-transparent number 5; while the screen of the sub-zone 4066 is labeled with a semi-transparent number 6. With such identifications, the user may clearly know the main zone corresponding to each sub-zone, so as to facilitate operation.

In a further embodiment, the display effect of the operating zone 406 may also be set with a display effect different from other main zones. For example, the display effect of the main zones 401-405 is normal, while the display effect of the operating zone 406 is semi-transparent, so as to facilitate the user to clearly know which main zone is set as the operating zone.

Then, the obtaining module 803 obtains a user's second input operation information with respect to the operating zone, the second input operating information being for operating a sub-zone therein. In the embodiment as shown in FIG. 4A, the obtaining module 803 captures the user's input operation information with respect to the operating zone 406, e.g., the user clicks the sub-zone 4062 in the operating zone 406.

Then, the second determining module 804 determines a main zone corresponding to said sub-zone. For example, in the embodiment as shown in FIG. 4A, when the user clicks the sub-zone 4062 in the operating zone 406, the second determining module 804 will determine a main zone corresponding to the sub-zone 4062 is 402.

Next, the position exchanging module 805 exchanges the positions of the determined main zone and the operating zone. It should be noted that exchanging the positions of the first zone and the second zone here means all contents in the first zone are completely exchanged to the initial position of the second zone, while all contents of the second zone are completely exchanged to the initial position of the first zone. For example, in the embodiment as shown in FIG. 4A, when the user clicks the sub-zone 4062 in the operating zone 406, the second determining module 804 will determine a main zone corresponding to the sub-zone 4062 is, 402; then, the position exchanging module 805 exchanges the positions of the main zone 402 and the operating zone 406. At this time, the display effect of the screen 400 is shown in FIG. 5. Because the operating zone 406 as shown in FIG. 4A is a zone that is easily operated by a thumb when single-handed operating, when the main zone 402 in FIG. 4A is exchanged to the position of the operating zone 406 in FIG. 4A, as shown in FIG. 5, the main zone 402 will become the zone that is easily operated when single-handed operating, while the main zone 402 as shown in FIG. 4A is the zone that is not easily operated by a thumb when single-handed operating. In this way, in the screen as shown in FIG. 5, the user can single-handed operate the contents in the main zone 402 very conveniently.

In a further embodiment, the apparatus 800 further comprises a third determining module (not shown in the figures).

The third determining module, responding to a fourth input operation information of a user, determines whether the fourth input operation information matches the preset input operation information for position restoration. For example, when the input operation information preset by the system for position restoration is clicking the screen beyond the operating zone thrice, then when the fourth input operation information captured by the touch screen device is clicking the screen beyond the operating zone thrice, the third determining module will determine that the fourth input operation information matches the preset input operation information for position restoration.

Preferably, the touch screen device further comprises a third updating module (not shown in the figures). The third updating module may update the input operation information preset for position restoration based on a user's input information. A user may define new input operation information for position restoration based on his/her own preferences and use habits.

If the fourth input operation information matches the input operation information preset for position restoration, the position exchanging module 805 re-exchanges the positions of the main zone and the operating zone of which the positions have been exchanged. For example, in the above embodiment, the screen after the positions of the main zone 402 and the operating zone 406 have been exchanged is shown in FIG. 5. Then, when the user's input operation information matches the input operation information preset for position restoration, the position exchanging module 805 re-exchanges the positions of the main zone 402 and the operating zone 406 (as shown in FIG. 5) after their positions have been exchanged. The screen after the re-exchange is shown in FIG. 4A.

With the method of the present invention, the user may perform single-handed operation of all contents in the screen. After the single-handed mode is launched, if the user intends to operate contents within a certain main zone, it is only needed to operate the sub-zone corresponding to the main zone within the operating zone; then, the position of the main zone will be exchanged with the position of the operating zone, such that the zone will be within a scope that is easily operated when single-handed operating, and the user would easily single-handed operate all contents within the zone.

In a further embodiment, the apparatus of the present invention further comprises a fourth determining module (not shown in the figures).

The fourth determining module, responding to a fifth input operation information of a user, determines whether the fifth input operation information matches preset input operation information for cancelling the single-handed mode. For example, if the input operation information preset by the system for cancelling the single-handed mode is up-down shaking the touch screen device, then when the fifth input operation information captured by the touch screen device is up-down shaking, it will be determined that the fifth input operation information matches the input operation information preset for cancelling the single-handed mode.

Preferably, the touch screen device further comprises a fourth updating module (not shown in the figures). The fourth updating module may update the input operation information preset for canceling a single-handed mode based on a user's input information. A user may define new input operation information for cancelling the single-handed mode based on his/her own preferences and use habits.

If the fifth input operation information matches input operation information preset for cancelling the single-handed mode, the dividing module 802 restores the screen to a normal display pattern. For example, when the screen 400 is as shown in FIG. 4A or FIG. 4B or FIG. 5, if the user's input operation information matches the input operation information preset for canceling the single-handed mode, then the dividing module 802 restores the screen 400 to the pattern of the screen before launching the single-handed mode, i.e., the pattern shown in FIG. 2.

It should be noted that the present invention may be implemented in software and/or a combination of software and hardware, for example, may be implemented by using an application-specific integrated circuit (ASIC), general purpose computer or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft disk or similar devices. Additionally, some steps or functions of the present invention may be implemented by hardware, for example, as a circuit cooperating with the processor so as to implement various steps of functions.

Additionally, a part of the present invention may be applied as a computer program product, e.g., computer program instructions, which, when being executed by a computer, may invoke or provide a method and/or technical solution according to the present invention. While the program instructions invoking the method of the present invention may be stored in a fixed or mobile recording medium, and/or transmitted through data stream in broadcast or other signal carrying medias, and/or stored in a work memory of a computer device operating according to the program instructions. Herein, one embodiment according to the present invention comprises an apparatus that includes a memory for storing computer program instructions and a processor for executing program instructions, wherein when being executed by the processor, the computer program instructions trigger the apparatus to operate the method and/or technical solution based on a plurality of embodiments of the present invention as mentioned above.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, and not limitative; the scope of the present invention is defined by the appended claims, instead of the above depiction. Thus, it is intended that all variations falling into the meaning and scope of equivalent elements of the claims are covered within the present invention. No reference signs in the claims should be regarded as limiting the involved claims. Besides, it is apparent that the term “comprise” does not exclude other elements or steps, and singularity does not exclude plurality. A plurality of elements or modules stated in an apparatus claim may also be implemented by a single element or module through software or hardware. Terms such as a first and a second are used to indicate names, other than indicate any particular sequence.

1. A method for operating a screen in a touch screen device, the method comprising:
responding to a first input operation information of a user, determining whether the first input operation information matches input operation information preset for launching a single-handed mode;
if the first input operation information matches the input operation information preset for launching a single-handed mode, dividing the screen into N (N>1) main zones based on preset configuration information, wherein one of the main zones is an operating zone, the operating zone being divided into N sub-zones, and the N main zones having a one-to-one correspondence to the N sub-zones;
obtaining a second input operation information of a user with respect to the operating zone, the second input operation information being for operating a sub-zone therein;
determining a main zone corresponding to the sub-zone;
exchanging the positions of the determined main zone and the operating zone.

2. The method according to claim 1, wherein the method further comprises:
receiving a third input operation information of a user, the third input operation information including at least one of the following:
the amount N of the main zones,
which of the N main zones is taken as the operating zone, and
a corresponding relationship between the N main zones and the N sub-zones;
updating the configuration information according to the third input information.

3. The method according to claim 1, wherein the method further comprises:
responding to a fourth input operation information of a user, determining whether the fourth input operation information matches input operation information preset for position restoration;
if the fourth input operation information matches the input operation information preset for position restoration, re-exchanging the positions of the main zone and the operation zone whose positions have been exchanged.

4. The method according to claim 1, wherein the method further comprises:
responding to a fifth input operation information of a user, determining whether the fifth input operation information matches input operation information preset for cancelling a single-handed mode;
if the fifth input operation information matches the input operation information preset for cancelling a single-handed mode, restoring the screen to be a normal display pattern.

5. The method according to claim 1, wherein the method further comprises:
updating the input operation information for launching a single-handed mode according to user input.

6. The method according to claim 3, wherein the method further comprises:
updating the input operation information for position restoration according to user input.

7. The method according to claim 4, wherein the method further comprises:
updating the input operation information for canceling a single-handed mode according to user input.

8. The method according to claim 1 or 2, wherein the method further comprises:
the display effect of the operating zone being different from the display effect of other N−1 main zones.

9. An apparatus for operating a screen in a touch screen device, the apparatus comprising:
a first determining module configured to, responding to a first input operation information of a user, determine whether the first input operation information matches input operation information preset for launching a single-handed mode;
a dividing module configured to, when the first input operation information matches the input operation information preset for launching a single-handed mode, divide the screen into N (N>1) main zones based on preset configuration information, wherein one of the main zones is an operating zone, the operating zone being divided into N sub-zones, and the N main zones having a one-to-one correspondence to the N sub-zones;
an obtaining module configured to obtain a second input operation information of a user with respect to the operating zone, the second input operation information being for operating a sub-zone therein;
a second determining module configured to determine a main zone corresponding to the sub-zone;
a position exchanging module configured to exchange the positions of the determined main zone and the operating zone.

10. The apparatus according to claim 9, wherein the apparatus further comprises:
a receiving module configured to receive a third input operation information of a user, the third input operation information including at least one of the following:
the amount N of the main zones,
which of the N main zones is taken as the operating zone, and
a corresponding relationship between the N main zones and the N sub-zones;
a first updating module configured to update the configuration information according to the third input information.

11. The apparatus according to claim 9, wherein the apparatus further comprises:
a third determining module configured to, responding to a fourth input operation information of a user, determine whether the fourth input operation information matches input operation information preset for position restoration;
the position exchanging module is further configured to, when the fourth input operation information matches the input operation information preset for position restoration, re-exchange the positions of the main zone and the operation zone whose positions have been exchanged.

12. The apparatus according to claim 9, wherein the apparatus further comprises:
a fourth determining module configured to, responding to a fifth input operation information of a user, determine whether the fifth input operation information matches input operation information preset for cancelling a single-handed mode;
the dividing module is further configured to, when the fifth input operation information matches the input operation information preset for cancelling a single-handed mode, restore the screen to be a normal display pattern.

13. The apparatus according to claim 9, wherein the apparatus further comprises:
a second updating module configured to update the input operation information for launching a single-handed mode according to user input.

14. The apparatus according to claim 11, wherein the apparatus further comprises:
a third updating module configured to update the input operation information for position restoration according to user input.

15. The apparatus according to claim 12, wherein the apparatus further comprises:
a fourth updating module configured to update the input operation information for canceling a single-handed mode according to user input.

16. The apparatus according to claim 9, wherein the display effect of the operating zone is different from the display effect of other N−1 main zones.
